(19) United States
(12) Patent Application Publication
(10) Pub. No.: US 2008/0062525 A1
(43) Pub. Date: Mar. 13, 2008

(54) Diffusion plate having surface microstructure

(75) Inventor: Wen-Feng Cheng, Taoyuan County (TW)

Correspondence Address: TROXELL LAW OFFICE PLLC, Suite 1404, 5205 Leesburg Pike, Falls Church, VA, 22041, US

(73) Assignee: ENTIRE TECHNOLOGY CO., LTD.

(21) Appl. No.: 11/518,403

(22) Filed: Sep. 11, 2006

(51) Int. Cl. G02B 5/02

(52) U.S. Cl. 359/599

(57) ABSTRACT

A diffusion plate having a surface microstructure comprises a plate and at least one microstructure, wherein the plate is made of a light-transmitting polymer having a UV absorbent and several diffusion particles doped therein. The microstructure is formed on at least one surface of the plate. By the use of the above-mentioned structure, the present invention can promote the diffusion capability of the diffusion plate and improve the diffusion plate's ability to cover the lamps.

### FIELD OF THE INVENTION

The present invention relates to a diffusion plate having a surface microstructure, and more particularly to a diffusion plate that utilizes the microstructure formed on the surface to provide many advantages including high light transmission rate, promoted diffusion capability and uniform light beams.

### BACKGROUND OF THE INVENTION

The modern people generally pick and purchase the LCD monitors, which are light and thin and not occupy too much space. In addition, they always aspire after larger size screen and lower price. As a result, the direct backlight modules, which apply to the large-size LCD monitors, have an increase in quantity demand year by year. In addition, the technical requirement for the direct backlight modules is also increased gradually. At present, all backlight module manufactures are diligent in developing new technology to promote the market competitiveness in the highly developed and competitive photoelectric industry for increasing the efficiency and reducing the cost.

However, the direct type backlight module must employ a critical component, namely, a diffusion plate. The conventional diffusion plate is flat and made of transparent polymer, for example, PMMA, PC, PS, or MS. In addition, the transparent polymer is doped with diffusion particles, and extruded into a diffusion substrate. Thereafter, the diffusion substrate is cut to obtain the required shape and size.

By the use of the aforesaid technology, the diffusion plate is provided with ability to cover the lamps and distribute the light uniformly. But, with the decrease of lamps in the 32 inches LCD TV, for example, from sixteen lamps to twelve lamps, the diffusion plate relatively requires a more powerful ability to cover the lamps instead of utilizing the diffusion particles alone. Accordingly, the diffusion ability of the diffusion plate and its ability to cover the lamps are needed to be improved.

### SUMMARY OF THE INVENTION

It is a primary object of the present invention to provide a diffusion plate having a surface microstructure, wherein the plate has several diffusion particles doped therein and the microstructure is formed on the outer surface of the plate in such a way that the light beams inside the diffusion plate can be reflected, refracted and scattered many times to provide the diffusion plate with high light transmission rate and improved diffusion capability for uniforming the light beams.

In order to achieve the above and other objects, a diffusion plate having a surface microstructure of the present invention is comprised of a plate and at least one microstructure, wherein the plate is made of a light-transmitting polymer, which has a UV absorbent and several diffusion particles doped therein. The microstructure is formed on at least one surface of the plate.

By the use of the above-mentioned structure, the present invention can overcome the conventional drawbacks so as to provide many advantages including high light transmission rate, promoted diffusion capability and uniform light beams.

### BRIEF DESCRIPTION OF THE DRAWINGS

FIG. 1 is a side view showing an internal structure of a diffusion plate in accordance with a first preferred embodiment of the present invention.

FIG. 2 is an elevational view showing a microstructure and another microstructure, which are perpendicular to each other on the diffusion plate of the present invention.

FIG. 3 is an elevational view showing a microstructure and another microstructure, which are parallel to each other on the diffusion plate of the present invention.

FIG. 4 is a side view showing a partial enlarged diagram of the microstructure formed on the diffusion plate in accordance with the first preferred embodiment of the present invention.

FIG. 5 is a side view showing a partial enlarged diagram of the microstructure formed on the diffusion plate in accordance with a second preferred embodiment of the present invention.

FIG. 6 is a side view showing a partial enlarged diagram of the microstructure formed on the diffusion plate in accordance with a third preferred embodiment of the present invention.

FIG. 7 is a side view showing a partial enlarged diagram of the microstructure formed on the diffusion plate in accordance with a fourth preferred embodiment of the present invention.

FIG. 8 is a side view showing a partial enlarged diagram of the microstructure formed on the diffusion plate in accordance with a fifth preferred embodiment of the present invention.

FIG. 9 is a side view showing a partial enlarged diagram of the microstructure formed on the diffusion plate in accordance with a sixth preferred embodiment of the present invention.

FIG. 10 is a side view showing a partial enlarged diagram of the microstructure formed on the diffusion plate in accordance with a seventh preferred embodiment of the present invention.

FIG. 11 is a side view showing a partial enlarged diagram of the microstructure formed on the diffusion plate in accordance with an eighth preferred embodiment of the present invention.

FIG. 12 is a side view showing a partial enlarged diagram of the microstructure formed on the diffusion plate in accordance with a ninth preferred embodiment of the present invention.

FIG. 13 is a side view showing an internal structure of a diffusion plate in accordance with a tenth preferred embodiment of the present invention.

FIG. 14 is a side view showing an internal structure of a diffusion plate in accordance with a nineteenth preferred embodiment of the present invention.

### DETAILED DESCRIPTION OF THE PREFERRED EMBODIMENT

Before explaining the present invention in more detail, it deserves to be specially noted that identical or analogous parts in the following description are generally indicated by identical reference numerals.

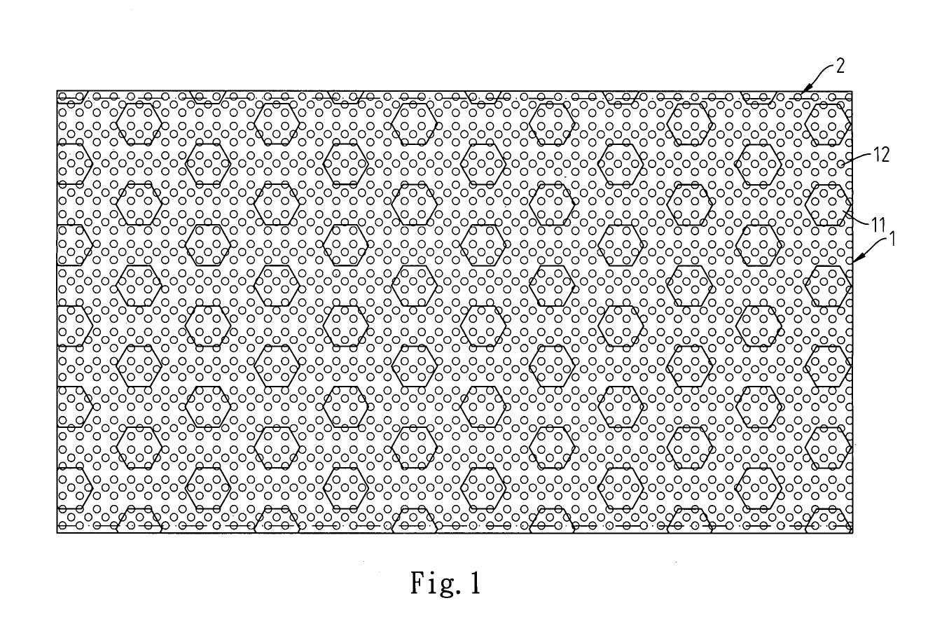

Referring to FIGS. 1 through 4, a diffusion plate having a surface microstructure in accordance with a first preferred embodiment of the present invention comprises a plate 1 and at least one microstructure 2.

The plate 1 is made of a light-transmitting polymer, which is polymethylmethacrylate (PMMA), polycarbonate (PC), methylmethacrylate/styrene copolymer (MS resin), or polystyrene (PS). In addition, the plate 1 has a UV absorbent 11 doped therein to prevent the direct UV light irradiation from causing the plate 1 to generate the phenomena of photoyellowing and cracking. In addition, the plate 1 has several diffusion particles 12 doped therein, wherein the diffusion particles 12 are polymethylmethacrylate (PMMA), polycarbonate (PC), titanium dioxide (TiO₂), or silicon dioxide (SiO₂). As a result, the phenomenon of optical diffusion occurs when the light passes through the diffusion particles 12.

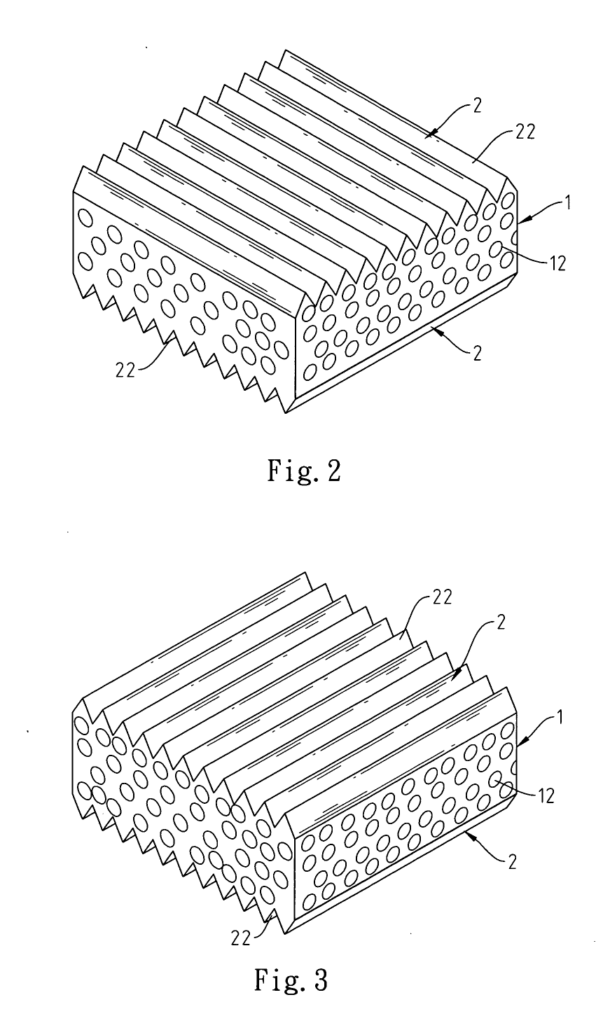

The microstructure 2 is formed on at least one surface of the aforesaid plate 1. In this preferred embodiment, this microstructure 2 and another microstructure 2 are arranged parallel (shown in FIG. 2) or perpendicular (shown in FIG. 3) to each other. Each of the microstructures comprises a plurality of parallel-arranged sine-wave bars 21, and the depth D between the peak and the trough of every sine-wave bar 21 is ranged between 0.01 mm and 0.3 mm, preferably between 0.05 mm and 0.15 mm. The distance P between two adjacent sine-wave bars 21 is ranged between 0.05 mm and 0.5 mm, preferably between 0.2 mm and 0.4 mm. The angle α shown in the figure is ranged between 120 degrees and 180 degrees. The symbol R shown in the figure is ranged between 0.43×P and 0.5×P.

Referring to FIG. 5, a diffusion plate of a second preferred embodiment of the present invention has a configuration similar to that of the first preferred embodiment. The difference is that the microstructure 2 of the second preferred embodiment has several parallel-arranged triangular bars 22. The depth D between the peak and the trough of every triangular bar 22 is ranged between 0.01 mm and 0.3 mm, preferably between 0.05 mm and 0.15 mm. The distance P between two adjacent triangular bars 22 is ranged between 0.05 mm and 0.5 mm, preferably between 0.2 mm and 0.4 mm. The angle α shown in the figure is ranged between 90 degrees and 130 degrees.

Referring to FIG. 6, a diffusion plate of a third preferred embodiment of the present invention has a configuration similar to that of the first preferred embodiment. The difference is that the microstructure 2 of the third preferred embodiment has several parallel-arranged semi-spherical bars 23. The depth D between the peak and the trough of every semi-spherical bar 23 is ranged between 0.01 mm and 0.3 mm, preferably between 0.05 mm and 0.15 mm. The distance P between two adjacent semi-spherical bars 23 is ranged between 0.05 mm and 0.5 mm, preferably between 0.2 mm and 0.4 mm. The angle α shown in the figure is ranged between 120 degrees and 180 degrees. The symbol R shown in the figure is ranged between 0.43×P and 0.5×P.

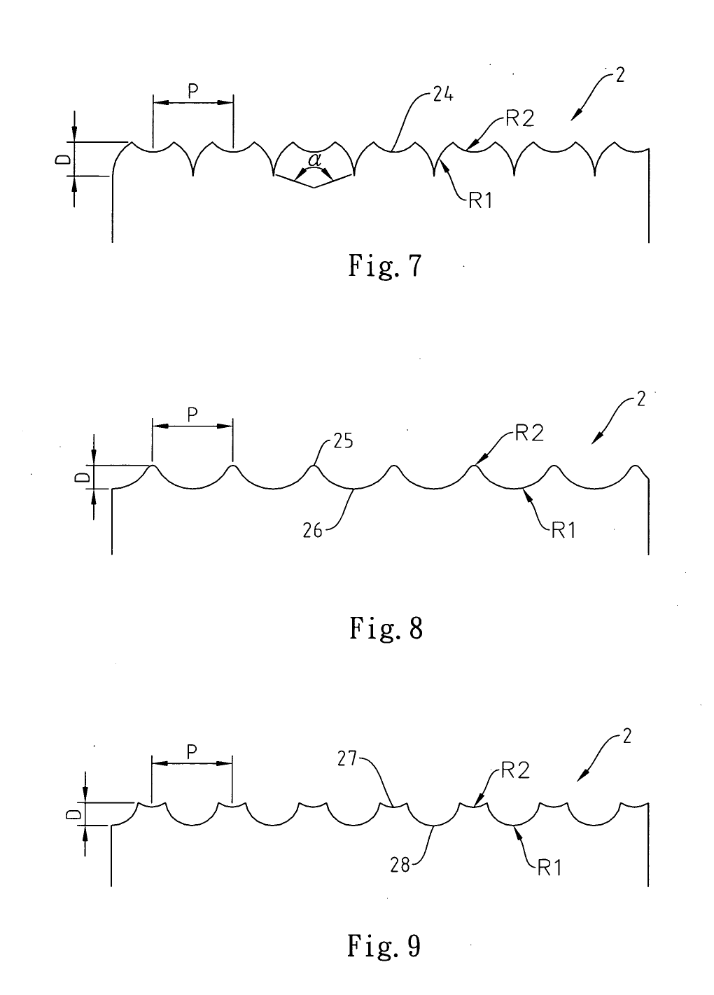

Referring to FIG. 7, a diffusion plate of a fourth preferred embodiment of the present invention has a configuration similar to that of the first preferred embodiment. The difference is that the microstructure 2 of the fourth preferred embodiment has several parallel-arranged polygonal bars 24. The depth D between the highest point and the lowest point of every polygonal bar 24 is ranged between 0.01 mm and 0.3 mm, preferably between 0.05 mm and 0.15 mm. The distance P between the centers of two adjacent polygonal bars 24 is ranged between 0.05 mm and 0.5 mm, preferably between 0.2 mm and 0.4 mm. The angle α shown in the figure is ranged between 120 degrees and 180 degrees. The symbol R1 shown in the figure is ranged between 0.43×P and 0.5×P. The symbol R2 shown in the figure is ranged between 0.5×R1 and R1.

Referring to FIG. 8, a diffusion plate of a fifth preferred embodiment of the present invention has a configuration similar to that of the first preferred embodiment. The difference is that the microstructure 2 of the fifth preferred embodiment has several parallel-arranged bars 25 and several trenches 26, wherein each trench 26 is formed between two adjacent bars 25. The depth D between the highest point of the bar 25 and the lowest point of the trench 26 is ranged between 0.01 mm and 0.3 mm, preferably between 0.05 mm and 0.15 mm. The distance P between the centers of two adjacent bars 25 is ranged between 0.05 mm and 0.5 mm, preferably between 0.2 mm and 0.4 mm. The symbol R1 shown in the figure is ranged between 0.43×P and 0.5×P. The symbol R2 shown in the figure is ranged between 0.1×R1 and 0.15×R1.

Referring to FIG. 9, a diffusion plate of a sixth preferred embodiment of the present invention has a configuration similar to that of the first preferred embodiment. The difference is that the microstructure 2 of the sixth preferred embodiment has several parallel-arranged reflection bars 27 and several reflection trenches 28, wherein every trench 28 is formed between two adjacent reflection bars 27. The depth D between the highest point of the reflection bar 27 and the lowest point of the reflection trench 28 is ranged between 0.01 mm and 0.3 mm, preferably between 0.05 mm and 0.15 mm. The distance P between the centers of two adjacent reflection bars 27 is ranged between 0.05 mm and 0.5 mm, preferably between 0.2 mm and 0.4 mm. The symbol R1 shown in the figure is ranged between 0.43×P and 0.5×P. The symbol R2 shown in the figure is ranged between 0.5×R1 and R1.

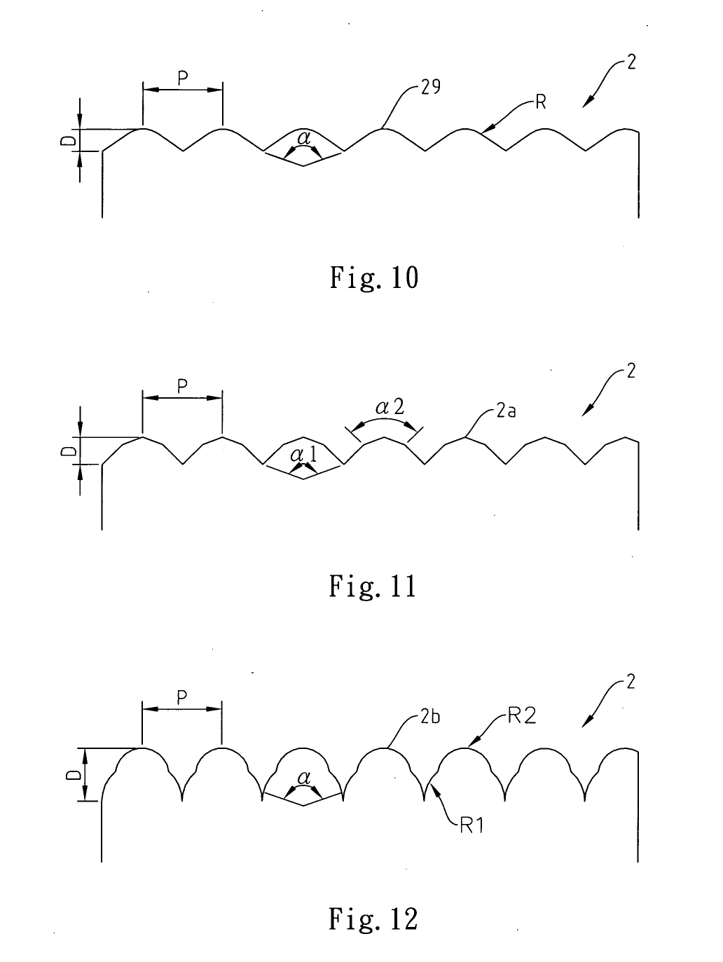

Referring to FIG. 10, a diffusion plate of a seventh preferred embodiment of the present invention has a configuration similar to that of the first preferred embodiment. The difference is that the microstructure 2 of the seventh preferred embodiment has several parallel-arranged semi-waveform bars 29. The depth D between the highest point and the lowest point of every semi-waveform bar 29 is ranged between 0.01 mm and 0.3 mm, preferably between 0.05 mm and 0.15 mm. The distance P between the centers of two adjacent semi-waveform bars 29 is ranged between 0.05 mm and 0.5 mm, preferably between 0.2 mm and 0.4 mm. The angle α shown in the figure is ranged between 90 degrees and 130 degrees. The symbol R shown in the figure is ranged between 0.1×P and 0.5×P.

Referring to FIG. 11, a diffusion plate of an eighth preferred embodiment of the present invention has a configuration similar to that of the first preferred embodiment. The difference is that the microstructure 2 of the eighth preferred embodiment has several parallel-arranged polygonal semi-waveform bars 2a. The depth D between the highest point and the lowest point of every polygonal semi-waveform bar 2a is ranged between 0.01 mm and 0.3 mm, preferably between 0.05 mm and 0.15 mm. The distance P between the centers of two adjacent polygonal semi-waveform bars 2a is ranged between 0.05 mm and 0.5 mm, preferably between 0.2 mm and 0.4 mm. The angles α1 and α2 shown in the figure are ranged between 90 degrees and 150 degrees.

Referring to FIG. 12, a diffusion plate of a ninth preferred embodiment of the present invention has a configuration similar to that of the first preferred embodiment. The difference is that the microstructure 2 of the ninth preferred embodiment has several parallel-arranged irregular semi-wave bars 2b. The depth D between the highest point and the lowest point of every irregular semi-wave bar 2b is ranged between 0.01 mm and 0.3 mm, preferably between 0.05 mm and 0.15 mm. The distance P between the centers of two adjacent irregular semi-wave bars 2b is ranged between 0.05 mm and 0.5 mm, preferably between 0.2 mm and 0.4 mm. The angle α shown in the figure is ranged between 120 degrees and 180 degrees. The symbol R1 shown in the figure is ranged between 0.43×P and 0.5×P. The symbol R2 shown in the figure is ranged between 0.5×R1 and 0.8×R1.

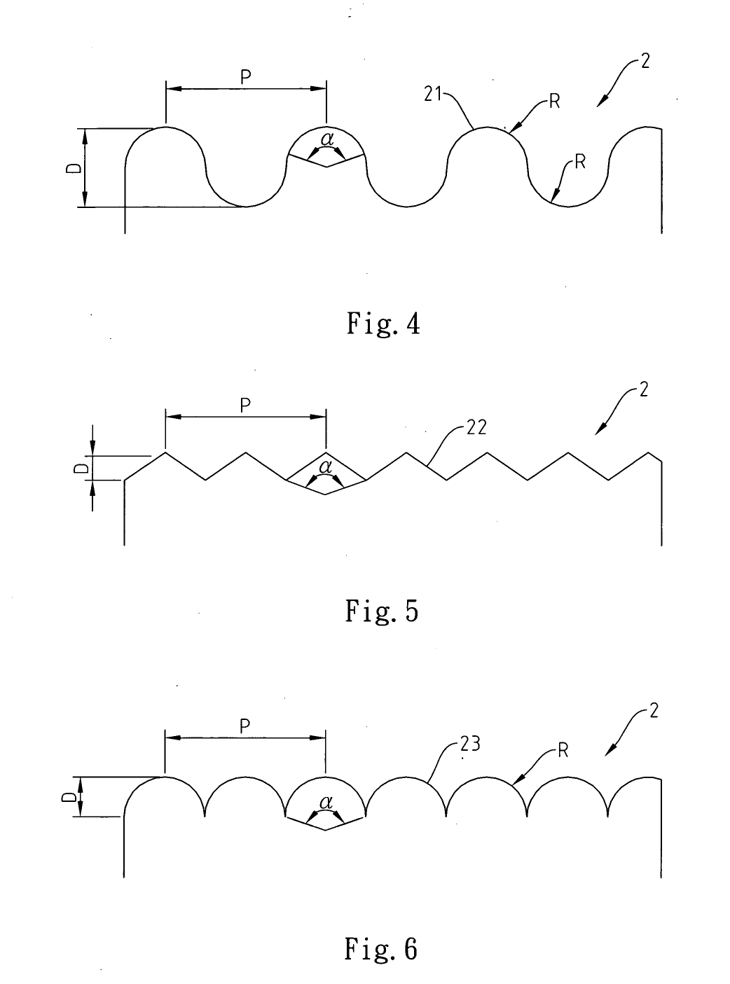

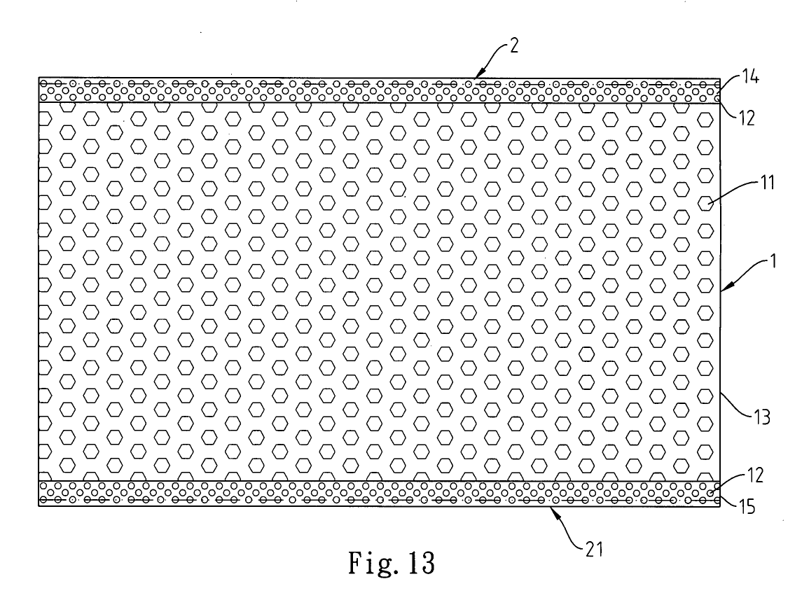

Referring to FIGS. 4 and 13, a diffusion plate having a surface microstructure in accordance with a tenth preferred embodiment of the present invention comprises a plate 1 and at least one microstructure 2.

The plate 1 is made of a light-transmitting polymer, which is polymethylmethacrylate (PMMA), polycarbonate (PC), methylmethacrylate/styrene copolymer (MS resin), or polystyrene (PS). The plate 1 comprises a core layer 13, a first auxiliary layer 14 formed on the top of the core layer 13, and a second auxiliary layer 15 formed on the bottom of the core layer 13. A UV absorbent 11 is doped into the core layer 13 or one of the first auxiliary layer 14 and the second auxiliary layer 15 to prevent the direct UV light irradiation from causing the plate 1 to generate the phenomena of photoyellowing and cracking. Several diffusion particles 12 are doped into the other one, wherein the diffusion particles 12 are polymethylmethacrylate (PMMA), polycarbonate (PC), titanium dioxide (TiO₂), or silicon dioxide (SiO₂). As a result, the phenomenon of optical diffusion occurs when the light passes through the diffusion particles 12.

The microstructure 2 is formed on at least one of the core layer 13, the first auxiliary layer 14, and the second auxiliary layer 15 of the plate 1. This microstructure 2 and another microstructure 2 are perpendicular (shown in FIG. 2) to each other. Each of the microstructures comprises a plurality of parallel-arranged sine-wave bars 21. The distance range of the sine-wave bar 21 is identical to that of the sine-wave bar 21 of the first preferred embodiment.

Referring to FIG. 5, a diffusion plate of an eleventh preferred embodiment of the present invention has a configuration similar to that of the tenth preferred embodiment. The difference is that the microstructure 2 of the eleventh preferred embodiment has several parallel-arranged triangular bars 22. The distance range of the microstructure 2 of the eleventh preferred embodiment is identical to that of the microstructure 2 of the second preferred embodiment.

Referring to FIG. 6, a diffusion plate of a twelfth preferred embodiment of the present invention has a configuration similar to that of the tenth preferred embodiment. The difference is that the microstructure 2 of the twelfth preferred embodiment has several parallel-arranged semi-spherical bars 23. The distance range of the microstructure 2 of the twelfth preferred embodiment is identical to that of the microstructure 2 of the third preferred embodiment.

Referring to FIG. 7, a diffusion plate of a thirteenth preferred embodiment of the present invention has a configuration similar to that of the tenth preferred embodiment. The difference is that the microstructure 2 of the thirteenth preferred embodiment has several parallel-arranged polygonal bars 24. The distance range of the microstructure 2 of the thirteenth preferred embodiment is identical to that of the microstructure 2 of the fourth preferred embodiment.

Referring to FIG. 8, a diffusion plate of a fourteenth preferred embodiment of the present invention has a configuration similar to that of the tenth preferred embodiment. The difference is that the microstructure 2 of the fourteenth preferred embodiment has several parallel-arranged bars 25 and several trenches 26, wherein each trench 26 is formed between two adjacent bars 25. The distance range of the microstructure 2 of the fourteenth preferred embodiment is identical to that of the microstructure 2 of the fifth preferred embodiment.

Referring to FIG. 9, a diffusion plate of a fifteenth preferred embodiment of the present invention has a configuration similar to that of the tenth preferred embodiment. The difference is that the microstructure 2 of the fifteenth preferred embodiment has several reflection bars 27 and several reflection trenches 28, wherein each reflection trench 28 is formed between two adjacent reflection bars 27. The distance range of the microstructure 2 of the fifteenth preferred embodiment is identical to that of the microstructure 2 of the sixth preferred embodiment.

Referring to FIG. 10, a diffusion plate of a sixteenth preferred embodiment of the present invention has a configuration similar to that of the tenth preferred embodiment. The difference is that the microstructure 2 of the sixteenth preferred embodiment has several semi-waveform bars 29. The distance range of the microstructure 2 of the sixteenth preferred embodiment is identical to that of the microstructure 2 of the seventh preferred embodiment.

Referring to FIG. 11, a diffusion plate of a seventeenth preferred embodiment of the present invention has a configuration similar to that of the tenth preferred embodiment. The difference is that the microstructure 2 of the seventeenth preferred embodiment has several polygonal semi-waveform bars 2a. The distance range of the microstructure 2 of the seventeenth preferred embodiment is identical to that of the microstructure 2 of the eighth preferred embodiment.

Referring to FIG. 12, a diffusion plate of an eighteenth preferred embodiment of the present invention has a configuration similar to that of the tenth preferred embodiment. The difference is that the microstructure 2 of the eighteenth preferred embodiment has several irregular semi-waveform bars 2b. The distance range of the microstructure 2 of the eighteenth preferred embodiment is identical to that of the microstructure 2 of the ninth preferred embodiment.

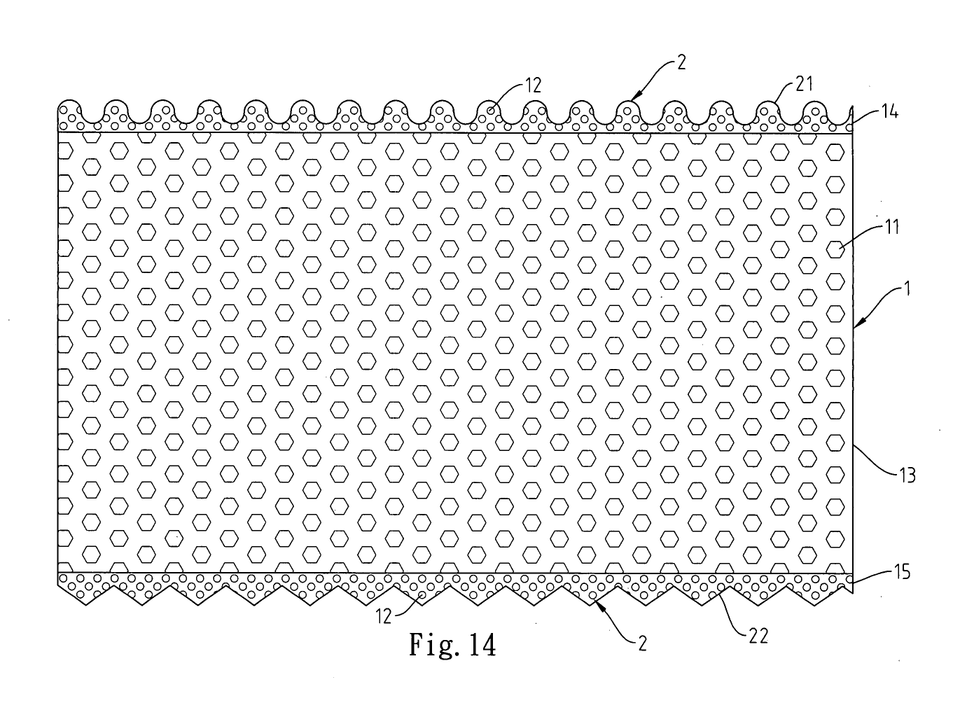

Referring to FIGS. 4, 5 and 14, a diffusion plate of an nineteenth preferred embodiment of the present invention has a configuration similar to that of the tenth preferred embodiment. The difference is that a microstructure 2, which has several parallel-arranged sine-wave bars 21, is formed on the top of the first auxiliary layer 14 of the nineteenth preferred embodiment. In addition, another microstructure 2, which has several parallel-arranged triangular bars 22, is formed on the bottom of the second auxiliary layer 15. As a result, the microstructure 2 of the tenth preferred embodiment and the microstructure 2 of the nineteenth preferred embodiment can be utilized together. In addition, the microstructures of the above-mentioned preferred embodiments may be utilized cooperatively so as to form varied microstructure 2 on the surface of the plate 1.

What the invention claimed is:

1. A diffusion plate having a surface microstructure comprising:
a plate made of a light-transmitting polymer; and
at least one microstructure formed on at least one surface of said plate.

2. A diffusion plate having a surface microstructure of claim 1, wherein said plate comprises a core layer, a first auxiliary layer formed on the top of said core layer, and a second auxiliary layer formed on the bottom of said core layer.

3. A diffusion plate having a surface microstructure of claim 1, wherein said at least one microstructure has a plurality of parallel-arranged sine-wave bars.

4. A diffusion plate having a surface microstructure of claim 1, wherein said at least one microstructure has a plurality of parallel-arranged triangular bars.

5. A diffusion plate having a surface microstructure of claim 1, wherein said at least one microstructure has a plurality of parallel-arranged semi-spherical bars.

6. A diffusion plate having a surface microstructure of claim 1, wherein said at least one microstructure has a plurality of parallel-arranged polygonal bars.

7. A diffusion plate having a surface microstructure of claim 1, wherein said at least one microstructure has a plurality of parallel-arranged bars and a plurality of trenches, and each trench is formed between two adjacent bars.

8. A diffusion plate having a surface microstructure of claim 1, wherein said at least one microstructure has a plurality of parallel-arranged reflection bars and a plurality of reflection trenches, and each reflection trench is formed between two adjacent reflection bars.

9. A diffusion plate having a surface microstructure of claim 1, wherein said at least one microstructure has a plurality of parallel-arranged semi-waveform bars.

10. A diffusion plate having a surface microstructure of claim 1, wherein said at least one microstructure has a plurality of parallel-arranged polygonal semi-waveform bars.

11. A diffusion plate having a surface microstructure of claim 1, wherein said at least one microstructure has a plurality of parallel-arranged irregular semi-waveform bars.

12. A diffusion plate having a surface microstructure of claim 1, wherein said light-transmitting polymer is polymethylmethacrylate (PMMA), polycarbonate (PC), methylmethacrylate/styrene copolymer (MS resin), or polystyrene (PS).

13. A diffusion plate having a surface microstructure of claim 1, wherein a UV absorbent is doped into said plate.

14. A diffusion plate having a surface microstructure of claim 1, wherein a plurality of diffusion particles are doped into said plate.

15. A diffusion plate having a surface microstructure of claim 1, wherein said diffusion particles are polymethylmethacrylate (PMMA), polycarbonate (PC), titanium dioxide (TiO₂), or silicon dioxide (SiO₂).
